(19) United States
(12) Patent Application Publication
(10) Pub. No.: US 2021/0129700 A1
(43) Pub. Date: May 6, 2021

(54) BATTERY CONTROL DEVICE AND VEHICLE HAVING SAME

(71) Applicant: SOMUNA CO., LTD., Gyeonggi-do (KR)

(72) Inventor: Jong Won SONG, Seoul (KR)

(21) Appl. No.: 17/252,845

(22) PCT Filed: Dec. 6, 2018
(86) PCT No.: PCT/KR2018/015388

§ 371 Date: Dec. 16, 2020

(30) Foreign Application Priority Data
Jun. 18, 2018 (KR) 10-2018-0069530

(51) Int. Cl. B60L 53/53; B60R 16/033; H02J 7/34; H02J 7/00

(52) U.S. Cl. CPC B60L 53/53; H02J 7/0068; H02J 7/34; B60R 16/033

(57) ABSTRACT

The present invention provides a vehicle having a battery control device comprising: a power generating device for generating power by receiving energy from an energy source; a main battery for charging the power generated from the power generating device; first and second secondary battery sets for charging auxiliary power remaining from the main battery, including at least two secondary batteries; a power consumption device for receiving power charged from any one of the first or second secondary battery sets, wherein a secondary battery set with a higher battery charge amount between the first and second secondary battery sets is connected to the power consumption device and the other secondary battery set is connected to the power generating device, by comparing the battery charge amount of the first and second secondary battery sets.

### TECHNICAL FIELD

The present invention relates to a battery control device and a vehicle having the same.

### RELATED ART

A vehicle includes a generator configured to produce power with driving power of an engine. The generator supplies power to various electronic devices, such as, for example, a head light and a panel of the vehicle and stores surplus power in a main battery. The power stored in the main battery may be used in a state in which the engine is stopped.

Meanwhile, the power generated by the generator while the vehicle is running is used to drive an air conditioner and to drive a refrigeration device or a freezing device of a dedicated truck having the refrigeration device or the freezing device.

Since the refrigeration device and the freezing device consume a relatively large amount of power, the power produced by the generator is immediately supplied to a compressor included in the refrigeration device or the freezing device.

In a state in which the engine of the vehicle is stopped, the compressor does not operate since electric power charged in the main battery is insufficient to meet an amount of power consumed by the refrigeration device or the freezing device.

As described above, when the engine of the dedicated truck having the refrigeration device or the freezing device is stopped, the refrigeration device and the freezing device may not run. In this case, a problem may occur in items stored in the refrigeration device and the freezing device.

### DETAILED DESCRIPTION

### Technical Subject

An object of the present invention is to provide a battery control device that does not need to maintain driving of an engine or a generator to operate a power consumption device during a stop and a vehicle having the same.

Also, an object of the present invention is to provide a battery control device that may quickly charge at least two secondary batteries included in a secondary battery set being charged in a parallel state and may supply larger power to at least two secondary batteries included in a secondary battery set being discharged in a series state, and a vehicle having the same.

Technical subjects to be accomplished herein are not limited to the aforementioned technical subjects and other technical subjects not described herein may be clearly understood from the following description by those skilled in the art to which the present invention pertains.

### Solution

To accomplish the aforementioned objects, provided is a vehicle having a battery control device, the vehicle including a power generation device configured to generate power with energy supplied from an energy source, a main battery configured to charge the power generated by the power generation device, first and second secondary battery sets each including at least two secondary batteries and configured to charge remaining surplus power after charging in the main battery, a power consumption device configured to be supplied with power charged from one of the first and second secondary battery sets, and the battery control device configured to compare a battery charge amount between the first and second secondary battery sets, and to connect a secondary battery set having a larger battery charge amount between the first and second secondary battery sets to the power consumption device and to connect a remaining secondary battery set to the power generation device.

Here, the energy source may include at least one of an engine, solar power, and wind power.

Also, the power generation device may include at least one of a generator configured to convert rotational energy to electrical energy and an energy conversion device configured to convert light energy to electrical energy.

Also, the vehicle may further include an emergency generator configured to supply power to the main battery and the first and second secondary battery sets in response to suspension of energy supply from the energy source.

Also, the battery control device may be configured to convert a connection of the at least two secondary batteries between a series connection and a parallel connection according to charging and discharging of the first and second secondary battery sets.

Also, the battery control device may be configured to connect in parallel the at least two secondary batteries included in the secondary battery set connected to the power generation device and to connect in series the at least two secondary batteries included in the secondary battery set connected to the power consumption device.

Also, the battery control device may be configured to connect a secondary battery set of which the battery charge amount is greater than or equal to a first reference value between the first and second secondary battery sets to the power consumption device.

Also, the battery control device may be configured to connect a secondary battery set of which the battery charge amount is less than a second reference value between the first and second secondary battery sets to the power generation device.

Also, the vehicle may further include a first switching unit configured to connect the first secondary battery set to one of the power generation device and the power consumption device and a second switching unit configured to connect the second secondary battery set to one of the power generation device and the power consumption device.

Also, the vehicle may further include a third switching unit configured to connect in either series or parallel the at least two secondary batteries included in the first secondary battery set and a fourth switching unit configured to connect in either series or parallel the at least two secondary batteries included in the second secondary battery set.

Also, provided is a battery control device including first and second battery sets each including at least two batteries, a charge amount comparator configured to compare a battery charge amount between the first and second battery sets and a charge and discharge controller configured to discharge a battery set of which the battery charge amount is larger between the first and second battery sets and to charge a remaining battery set, to connect in parallel the at least two batteries included in the battery set being charged and to connect in series the at least two batteries included in the battery set being discharged.

Also, the battery control device may further include a first switching unit configured to connect the first battery set to one of a power generation device and a power consumption device and a second switching unit configured to connect the second battery set to one of the power generation device and the power consumption device.

Also, the battery control device may further include a third switching unit configured to connect in either series or parallel the at least two batteries included in the first battery set and a fourth switching unit configured to connect in either series or parallel the two batteries included in the second battery set.

Also, the power generation device may be configured to generate power with energy supplied from an energy source including at least one of an engine, solar power and wind power.

Also, the power generation device may include at least one of a generator configured to convert rotational energy to electrical energy and an energy conversion device configured to convert energy to electrical energy.

### Effect

According to the present invention, since a battery charge amount of one of two secondary battery sets is maintained to be greater than or equal to a reference value and a power consumption device is supplied with charging power from a secondary battery set not connected to a power generation device, there is no need to maintain driving of an engine or a generator to operate the power consumption device during a stop.

Also, according to the present invention, it is possible to quickly charge at least two secondary batteries included in a secondary battery set being charged in a parallel state and to supply larger power to at least two secondary batteries included in a secondary battery set being discharged in a series state. The effects of the present invention are not limited thereto and other effects not described herein may be clearly understood by those skilled in the art from the following description.

### BRIEF DESCRIPTION OF DRAWINGS

FIG. 1 is a block diagram illustrating a vehicle having a battery control device according to an example embodiment of the present invention.

FIG. 2 is a block diagram of a battery control device according to an example embodiment of the present invention.

FIG. 3 is a circuit diagram of a secondary battery set according to an example embodiment of the present invention.

FIGS. 4 and 5 are circuit diagrams according to a control operation of a battery control device according to an example embodiment of the present invention.

FIG. 6 is an equivalent circuit diagram of FIG. 4.

FIG. 7 is an equivalent circuit diagram of FIG. 5.

### MODE

Example embodiments of the present invention are described in detail with reference to the accompanying drawings. Although they are illustrated in different drawings, like reference numerals refer to like elements throughout and repeated description related thereto is omitted.

Also, when it is deemed that detailed description related to the known art makes the present invention ambiguous in describing the present invention, the detailed description is omitted. Also, the accompanying drawings are provided to help understanding of the spirit of the present invention and it should be noted that the spirit of the present invention is not limited thereto.

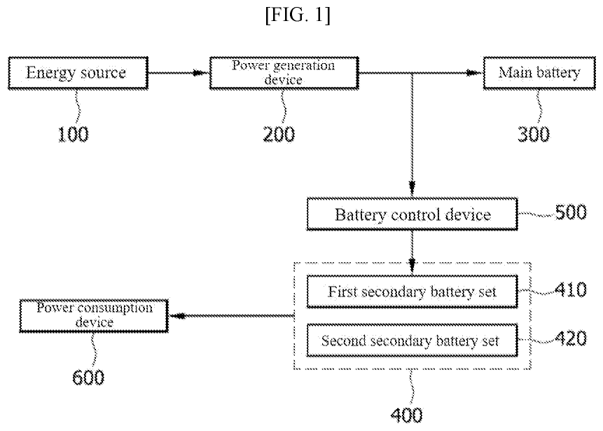

FIG. 1 is a block diagram of a vehicle having a battery control device according to an example embodiment of the present invention.

Referring to FIG. 1, the vehicle having the battery control device according to an example embodiment of the present invention may include a power generation device 200, a main battery 300, a secondary battery set 400, a battery control device 500, and a power consumption device 600.

The power generation device 200 is supplied with energy from an energy source 100 and generates power.

Here, the energy source 100 may include at least one of an engine, solar power, and wind power. However, it is provided as an example only and various types of renewable energy sources may be employed.

In detail, the power generation device 200 may generate power by using one of the engine, the solar power, and the wind power as a standalone energy source or may generate power by using a combination of the engine and the solar power or a combination of the engine and the wind power as a hybrid energy source.

Accordingly, the power generation device 200 may include at least one of a power generation device configured to convert rotational energy to electrical energy by at least one of the engine and the wind power and an energy conversion device configured to convert light energy to electrical energy by the solar power.

Meanwhile, although not illustrated, the vehicle having the battery control device according to an example embodiment may further include an emergency generator configured to supply power to the main battery 300 and the secondary battery set 400 when energy supply from the energy source 100 is stopped.

Accordingly, in response to occurrence of an emergency situation in which the energy supply from the energy source 100 is stopped, the main battery 300 and the secondary battery set 400 may be charged by automatically driving the emergency generator.

The main battery 300 charges the power generated by the power generation device 200.

The secondary battery set 400 may include at least two sets. Hereinafter, the vehicle having the battery control device according to an example embodiment of the present invention is described by classifying the secondary battery set 400 into a first secondary battery set 410 and a second secondary battery set 420.

Each of the first secondary battery set 410 and the second secondary battery set 420 includes at least two secondary batteries and charges remaining surplus power after charging in the main battery 300.

The power consumption device 600 may be a power consumption device, such as an air conditioner, a refrigeration device, and a freezing device, using relatively great power in addition to a general power consumption device, such as a head light, a panel, an audio, and a wiper.

Meanwhile, due to the limited capacity of the main battery 300, there are some constraints in supplying the power to all of the general power consumption device, such as an audio and a wiper, and the power consumption device 300, such as an air conditioner, a refrigeration device, and a freezing device, only with the main battery 300.

Also, due to the limited capacity of the main battery 300, there is a need to drive the engine or the generator even during a stop to smoothly drive the power consumption device 600, such as an air conditioner, a refrigeration device, and a freezing device.

To solve this, the vehicle having the battery control device according to an example embodiment of the present invention includes the secondary battery set 400 in addition to the main battery 300, supplies power charged in the main battery 300 to the general power consumption device, such as an audio and a wiper, and supplies the power charged in the secondary battery set 400 to the power consumption device 600, such as an air conditioner, a refrigeration device, and a freezing device.

Here, the power consumption device 600 is supplied with charged power from one of the first secondary battery set 410 and the second secondary battery set 420.

To this end, the battery control device 500 selectively charges surplus power to the first secondary battery set 410 and the second secondary battery set 420 and selectively discharges the power charged in the first secondary battery set 410 and the second secondary battery set 420 to the power consumption device 600.

In detail, the battery control device 500 compares battery charge amounts of the first secondary battery set 410 and the second secondary battery set 420, connects the secondary battery set 400 having a larger battery charge amount between the first secondary battery set 410 and the second secondary battery set 420 to the power consumption device 600 and connects the remaining secondary battery set 400 to the power generation device 200.

As described above, in the vehicle having the battery control device according to an example embodiment of the present invention, since the power consumption device 600 is supplied with charging power from the secondary battery set 400 not connected to the power generation device 200, there is no need to maintain driving of an engine or a generator to drive the power consumption device 600 during a stop.

The battery control device 500 converts a connection of the at least two secondary batteries between a series connection and a parallel connection according to charging and discharging of the first secondary battery set 410 and the second secondary battery set 420.

In detail, the battery control device 500 connects secondary batteries included in the secondary battery sets 410 and 420 in parallel at a time of charging of the first secondary battery set 410 and the second secondary battery set 420 and converts the parallel connection to the series connection at a time of discharging.

Also, the battery control device 500 connects secondary batteries included in the secondary battery sets 410 and 420 in series at a time of discharging of the first secondary battery set 410 and the second secondary battery set 420 and converts the series connection to the parallel connection at a time of charging.

The battery control device 500 connects in parallel the at least two secondary batteries included in the secondary battery set 400 connected to the power generation device 200 and connects in series the at least two secondary batteries included in the secondary battery set 400 connected to the power consumption device 600.

Here, if at least two secondary batteries are charged in a parallel connection state, a charging time is reduced by 1/2 times compared to a case in which charging is performed in a series connection state. Also, if at least two secondary batteries are discharged in the series connection state, an amount of power supplied quadruples compared to a case in which discharging is performed in the parallel connection state.

Accordingly, the vehicle having the battery control device according to an example embodiment of the present invention may quickly charge the at least two secondary batteries included in the secondary battery set 400 being charged in a parallel state and may supply larger power to the at least two secondary batteries included in the secondary battery set 400 being discharged in a series state.

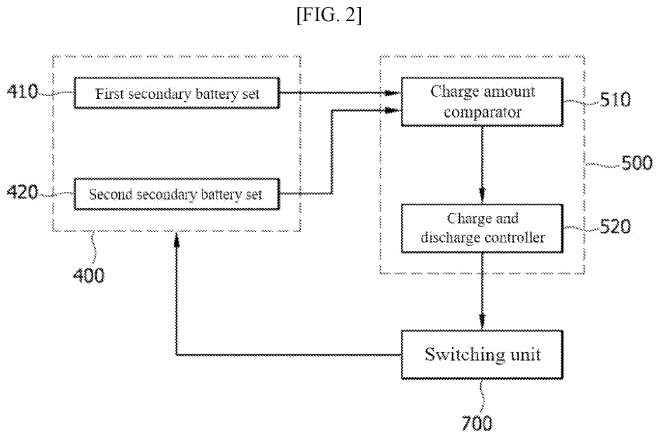

FIG. 2 is a block diagram of a battery control device according to an example embodiment of the present invention.

Referring to FIG. 2, the battery control device 500 may include a charge amount comparator 510 and a charge and discharge controller 520.

Here, the charge amount comparator 510 receives a battery charge amount of each of the first secondary battery set 410 and the second secondary battery set 420 and compares the battery charge amount of the first secondary battery set 410 and the battery charge amount of the second secondary battery set 420.

The charge and discharge controller 520 controls charging and discharging of the first secondary battery set 410 and second secondary battery set 420 based on the battery charge amount comparison result.

In detail, the charge and discharge controller 520 discharges the secondary battery set 400 having a larger battery charge amount between the first secondary battery set 410 and the second secondary battery set 420 and charges the remaining secondary battery set 420.

The charge and discharge controller 520 connects in parallel the at least two secondary batteries included in the secondary battery set 400 being charged and connects in series the at least two secondary batteries included in the secondary battery set 400 being discharged.

The charge and discharge controller 520 connects the secondary battery set 400 of which the battery charge amount is greater than or equal to a first reference value between the first secondary battery set 410 and the second secondary battery set 420 to the power consumption device 600. Here, the first reference value may be 70 to 100% of a full battery charge amount.

The charge and discharge controller 520 connects the secondary battery set 400 of which the battery charge amount is less than a second reference value between the first secondary battery set 410 and the second secondary battery set 420 to the power generation device 200. Here, the second reference value may be 0 to 30% of the full battery charge amount.

For example, during a time in which the first secondary battery set 410 having the battery charge amount of the first reference value or more supplies the charged power to the power consumption device 600, the second secondary battery set 420 is supplied with surplus power from the power generation device 200 and the battery charge amount becomes to be greater than or equal to the first reference value. If the battery charge amount of the first secondary battery set 410 is less than the second reference value, the first secondary battery set 410 is charged through connection to the power generation device 200 and the second secondary battery set 420 is discharged through connection to the power consumption device 600.

By repeating the above process, power may be continuously supplied to the power consumption device 600. In particular, a battery charge amount of one of the first secondary battery set 410 and the second secondary battery set 420 is maintained to be greater than or equal to the first reference value and the power consumption device 600 is supplied with charging power from the secondary battery set 400 not connected to the power generation device 200. Therefore, there is no need to maintain driving of an engine or a generator to operate the power consumption device 600 during a stop.

Meanwhile, if all of battery charge amounts of the first secondary battery set 410 and the second secondary battery set 420 are greater than or equal to the first reference value, the charge and discharge controller 520 may connect in parallel the first secondary battery set 410 and the second secondary battery set 420 and may connect the same to the power consumption device 600, thereby further stably supplying power to the power consumption device 600.

After supplying power to the power consumption device 600 through the first secondary battery set 410 and the second secondary battery set 420, the charge and discharge controller 520 connects the secondary battery set 400 of which the battery charge amount is less than a third reference value between the first secondary battery set 410 and the second secondary battery set 420 to the power generation device 200. Here, the third reference value refers to a value greater than the second reference value and may be 30 to 70% of the full battery charge amount.

The first reference value to the third reference value may be preset based on consumption power of the power consumption device 600, capacity of the secondary battery set 400, and average daily driving time of the vehicle such that the battery charge amount of one of the first secondary battery set 410 and the second secondary battery set 420 may be maintained as the first reference value.

Here, a standard of the battery charge amount is determined as the third reference value based on the following reasons. Since battery charge amounts of all of the first secondary battery set 410 and the second secondary battery set 420 are initially greater than or equal to the first reference value and a deviation thereof is not great, the first secondary battery set 410 and the second secondary battery set 420 are simultaneously discharged. Therefore, a probability that all of the battery charge amounts become the second reference value may increase and all of the first secondary battery set 410 and the second secondary battery set 420 may be connected to the power generation device 200 and accordingly, continuity of power supplied to the power consumption device 600 may be broken.

Accordingly, the charge and discharge controller 520 of the battery control device according to an example embodiment of the present invention may stably supply power to the power consumption device 600 through the first secondary battery set 410 and the second secondary battery set 420 and then may charge by connecting a secondary battery set with a decreased battery charge amount between the secondary battery sets to the power generation device 200 and may continuously supply power to the power consumption device 600 through a remaining secondary battery set.

Also, at a time at which the connection of the power consumption device 600 is switched between the first secondary battery set 410 and the second secondary battery set 420, the continuity of power supplied to the power consumption device 600 may be broken.

Accordingly, the charge and discharge controller 520 of the battery control device according to an example embodiment of the present invention may maintain the continuity of power supplied to the power consumption device 600 by connecting all of the first secondary battery set 410 and the second secondary battery set 420 to the power consumption device 600 before switching the connection between each secondary battery set 400 and the power consumption device 600.

For example, when the first secondary battery set 410 is connected to the power consumption device 600 and then the second secondary battery set 420 is switched to be connected thereto, the charge and discharge controller 520 switches a connection of the first secondary battery set 410 from the power consumption device 600 to the power generation device 200 after the second secondary battery set 420 is connected to the power consumption device 600, instead of immediately switching the connection of the first secondary battery set 410 from the power consumption device 600 to the power generation device 200.

Referring to FIG. 2, the vehicle having the battery control device according to an example embodiment of the present invention may further include a switching unit 700.

The switching unit 700 is switched ON or OFF in response to receiving a switching control signal from the charge and discharge controller 520, and changes a circuit connection relation between the first secondary battery set 410 and the second secondary battery set 420 and the power generation device 200 and the power consumption device 600, and changes a circuit connection relation between the at least two secondary batteries included in each of the first secondary battery set 410 and the second secondary battery set 420.

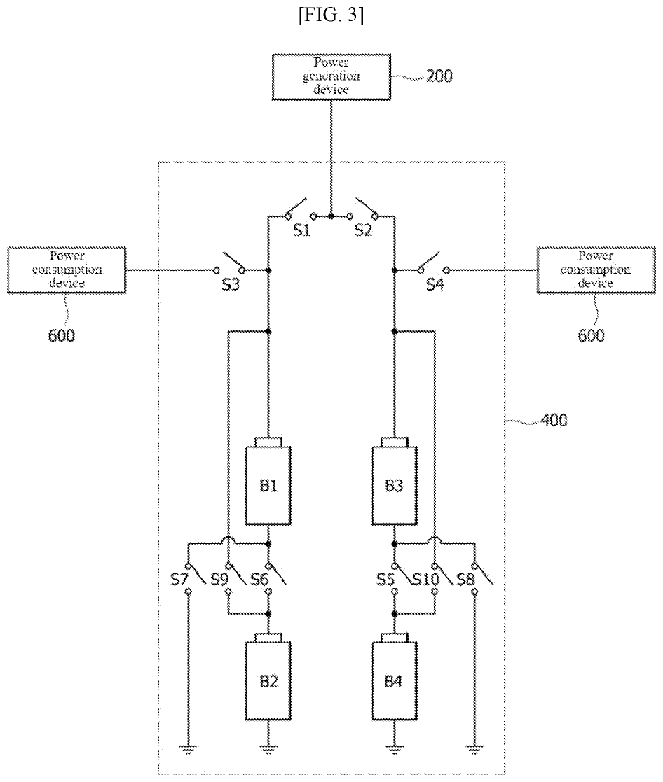

FIG. 3 is a circuit diagram of a secondary battery set according to an example embodiment of the present invention.

Meanwhile, the circuit diagram of FIG. 3 is provided as an example only and may be modified in various forms.

Referring to FIG. 3, the first secondary battery set 410 may include a first secondary battery B1 and a second secondary battery B2, and the second secondary battery set 420 may include a third secondary battery B3 and a fourth secondary battery B4.

Here, the first to fourth secondary batteries B 1, B2, B3, and B4 may have the same capacity, that is, the same rated output voltage.

The switching unit 700 may include first switch S1 to tenth switch S10, which may be classified into a first switching unit to a fourth switching unit based on a function thereof.

The first switching unit (S1, S3) connects the first secondary battery set 410 to one of the power generation device 200 and the power consumption device 600 in response to a switching control signal of the charge and discharge controller 520. The second switching unit (S2, S4) connects the second secondary battery set 420 to one of the power generation device 200 and the power consumption device 600 in response to the switching control signal of the charge and discharge controller 520.

The third switching unit (S6, S7, S9) connects in either series or parallel at least two secondary batteries ((B1, B2), (B3, B4)) included in the first secondary battery set 410 in response to the switching control signal of the charge and discharge controller 520. The fourth switching unit (S5, S8, S10) connects in either series or parallel at least two secondary batteries ((B1, B2), (B3, B4)) included in the second secondary battery set 420 in response to the switching control signal of the charge and discharge controller 520.

Here, the first switching unit may include the first switch S1 and the third switch S3, the second switching unit may include the second switch S2 and the fourth switch S4, the third switching unit may include the sixth switch S6, the seventh switch S7, and the nineth switch S9, and the fourth switching unit may include the fifth switch S5, the eighth switch S8, and the tenth switch S10.

The power generation device 200 may be connected to the first switch S1 and the second switch S2 and the power consumption device 600 may be connected to the third switch S3 and the fourth switch S4.

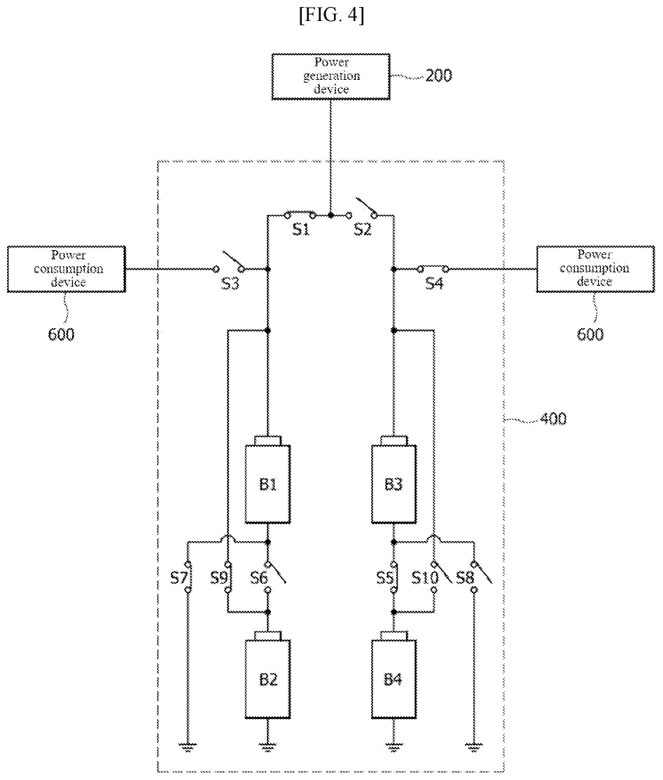

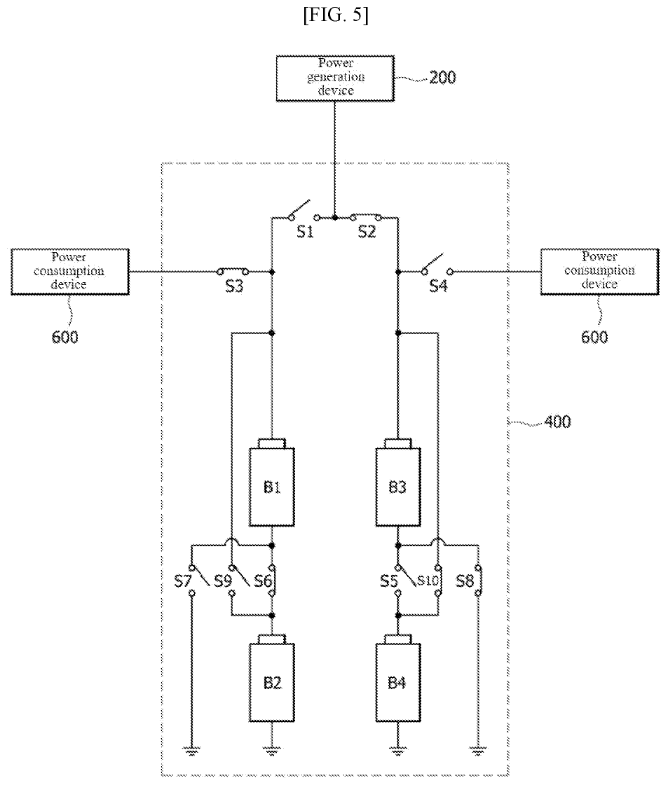

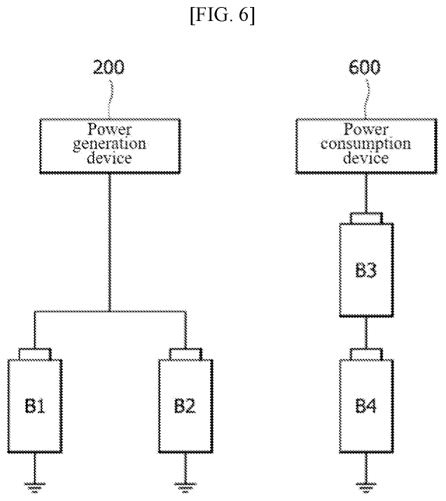

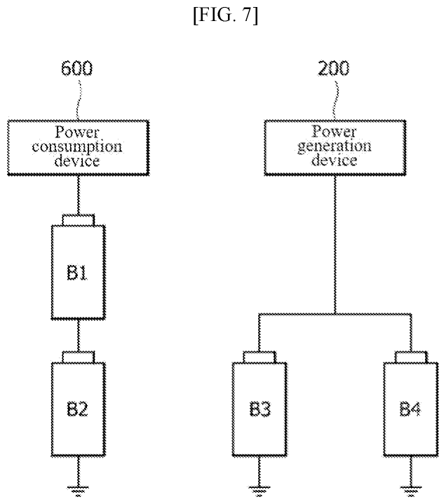

FIGS. 4 and 5 are circuit diagrams according to a control operation of a battery control device according to an example embodiment of the present invention. FIG. 6 is an equivalent circuit diagram of FIG. 4 and FIG. 7 is an equivalent circuit diagram of FIG. 5.

Referring to FIGS. 4 and 5, the first switch S1 and the third switch S3 connect the first secondary battery set 410 to one of the power generation device 200 and the power consumption device 600 in response to a switching control signal of the charge and discharge controller 520. The second switch S2 and the fourth switch S4 connect the second secondary battery set 420 to one of the power generation device 200 and the power consumption device 600 in response to the switching control signal of the charge and discharge controller 520.

Here, if the first secondary battery set 410 is connected to the power consumption device 600, the second secondary battery set 420 may be connected to the power generation device 200. On the contrary, if the second secondary battery set 420 is connected to the power consumption device 600, the first secondary battery set 410 may be connected to the power generation device 200.

Also, the sixth switch S6, the seventh switch S7, and the nineth switch S9 connect in either series or parallel the first secondary battery B1 and the second secondary battery B2 included in the first secondary battery set 410 in response to the switching control signal of the charge and discharge controller 520.

The fifth switch S5, the eighth switch S8, and the tenth switch S10 connect in either series or parallel the third secondary battery B3 and the fourth secondary battery B4 included in the second secondary battery set 420 in response to the switching control signal of the charge and discharge controller 520.

In detail, referring to FIGS. 4 and 6, if the first switch S1 is ON and the third switch S3 is OFF, the first secondary battery set 410 is connected to the power generation device 200 and charges surplus power from the power generation device 200. If the second switch S2 is OFF and the fourth switch S4 is ON, the second secondary battery set 420 is connected to the power consumption device 600 and supplies the charged power to the power consumption device 600.

If the seventh switch S7 and the nineth switch S9 are ON and the sixth switch S6 is OFF, the first secondary battery B1 and the second secondary battery B2 are connected in parallel. If the eighth switch S8 and the tenth switch S10 are OFF and the fifth switch S5 is ON, the third secondary battery B3 and the fourth secondary battery B4 are connected in series.

From this, the first secondary battery B1 and the second secondary battery B2 connected in parallel are connected to the power generation device 200 and charges surplus power from the power generation device 200. The third secondary battery B3 and the fourth secondary battery B4 connected in series are connected to the power consumption device 600 and supplies the charged power to the power consumption device 600.

Here, if the first secondary battery B1 and the second secondary battery B2 are charged in a parallel connection state, a charging time may be reduced by 1/2 times compared to a case in which charging is performed in a series connection state.

Accordingly, the first secondary battery B1 and the second secondary battery B2 included in the first secondary battery set 410 being charged may be quickly charged in a parallel state.

If the third secondary battery B3 and the fourth secondary battery B4 are discharged in the series connection state, a power supply may quadruple compared to a case in which discharging is performed in the parallel connection state.

For example, with the assumption that raged output voltage of each of the third secondary battery B3 and the second secondary battery B4 is 12V, the output voltage is 12V in the case of discharging in the parallel connection state. However, in the case of discharging in the series connection state, the output voltage is 24V.

As described above, the vehicle having the battery control device according to an example embodiment of the present invention may drive the power consumption device 600 with the rated voltage of 24V using the secondary battery with the rated output voltage of 12V by implementing a boost circuit during discharge.

Accordingly, the third secondary battery B3 and the fourth secondary battery B4 connected in series may supply the quadrupled power compared to that in the parallel connection state.

That is, to supply power to the power consumption device 600 that requires relatively great power, there is no need to increase the capacity of the secondary battery set 400. Therefore, it is possible to save cost according to providing of the secondary battery set 400 having the relatively large capacity and to reduce an area occupied by the secondary battery set 400 in a limited in-vehicle space.

Referring to FIGS. 5 and 7, if the second switch S2 is ON and the fourth switch S4 is OFF, the second secondary battery set 420 is connected to the power generation device 200 and charges surplus power from the power generation device 200. If the first switch S1 is OFF and the third switch S3 is ON, the first secondary battery set 410 is connected to the power consumption device 600 and supplies the charged power to the power consumption device 600.

If the eighth switch S8 and the tenth switch S10 are ON and the fifth switch S5 is OFF, the third secondary battery B3 and the fourth secondary battery B4 are connected in parallel. If the seventh switch S7 and the nineth switch S9 are OFF and the sixth switch S6 is ON, the first secondary battery B1 and the second secondary battery B2 are connected in series.

From this, the third secondary battery B3 and the fourth secondary battery B4 connected in parallel are connected to the power generation device 200 and charges surplus power from the power generation device 200. The first secondary battery B1 and the second secondary battery B2 connected in series are connected to the power consumption device 600 and supplies the charged power to the power consumption device 600.

Here, if the third secondary battery B3 and the fourth secondary battery B4 are charged in a parallel connection state, a charging time is reduced by 1/2 times compared to a case in which charging is performed in a series connection state.

Accordingly, the third secondary battery B3 and the fourth secondary battery B4 included in the second secondary battery set 420 being charged may be quickly charged in a parallel state.

If the first secondary battery B1 and the second secondary battery B2 are discharged in the series connection state, a power supply may quadruple compared to a case in which discharging is performed in the parallel connection state.

For example, with the assumption that the rated output voltage of each of the first secondary battery B1 and the second secondary battery B2 is 12V, the output voltage is 12V in the case of discharging in the parallel connection state. However, in the case of discharging in the series connection state, the output voltage is 24V.

As described above, the vehicle having the battery control device according to an example embodiment of the present invention may drive the power consumption device 600 with the rated voltage of 24V using the secondary battery with the rated output voltage of 12V by implementing a boost circuit during discharge.

Accordingly, the first secondary battery B1 and the second secondary battery B2 connected in series may supply the quadrupled power compared to that in the parallel connection state.

That is, to supply power to the power consumption device 600 that requires relatively large power, there is no need to increase the capacity of the secondary battery set 400. Therefore, it is possible to save cost according to providing of the secondary battery set 400 having the relatively large capacity and to reduce an area occupied by the secondary battery set 400 in a limited in-vehicle space.

The example embodiments described herein and the accompanying drawings are provided as an example only to explain a portion of the technical spirit included in the present invention. Therefore, the example embodiments disclosed herein are not construed to limit the technical spirit of the present invention and are merely provided to explain the same and thus, it is evident that the scope of the technical spirit of the present invention is not limited by the example embodiments. It should be interpreted that modification examples and specific example embodiments easily derivable by those skilled in the art within the scope of the technical spirit included in the present specification and drawings are included in the scope of the present invention.

### INDUSTRIAL APPLICABILITY

A battery control device and a vehicle having the same according to the present invention may apply in various battery control fields.

What is claimed is:

1. A vehicle having a battery control device, the vehicle comprising:
a power generation device configured to generate power with energy supplied from an energy source;
a main battery configured to charge the power generated by the power generation device;
first and second secondary battery sets each comprising at least two secondary batteries and configured to charge remaining surplus power after charging in the main battery;
a power consumption device configured to be supplied with power charged from one of the first and second secondary battery sets; and
the battery control device configured to compare a battery charge amount between the first and second secondary battery sets, and to connect a secondary battery set having a larger battery charge amount between the first and second secondary battery sets to the power consumption device and to connect a remaining secondary battery set to the power generation device.

2. The vehicle of claim 1, wherein the energy source comprises at least one of an engine, solar power, and wind power.

3. The vehicle of claim 1, wherein the power generation device comprises at least one of:
a generator configured to convert rotational energy to electrical energy; and
an energy conversion device configured to convert light energy to electrical energy.

4. The vehicle of claim 1, further comprising:
an emergency generator configured to supply power to the main battery and the first and second secondary battery sets in response to suspension of energy supply from the energy source.

5. The vehicle of claim 1, wherein the battery control device is configured to convert a connection of the at least two secondary batteries between a series connection and a parallel connection according to charging and discharging of the first and second secondary battery sets.

6. The vehicle of claim 1, wherein the battery control device is configured to connect in parallel the at least two secondary batteries included in the secondary battery set connected to the power generation device and to connect in series the at least two secondary batteries included in the secondary battery set connected to the power consumption device.

7. The vehicle of claim 1, wherein the battery control device is configured to connect a secondary battery set of which the battery charge amount is greater than or equal to a first reference value between the first and second secondary battery sets to the power consumption device.

8. The vehicle of claim 1, wherein the battery control device is configured to connect a secondary battery set of which the battery charge amount is less than a second reference value between the first and second secondary battery sets to the power generation device.

9. The vehicle of claim 1, further comprising:
a first switching unit configured to connect the first secondary battery set to one of the power generation device and the power consumption device; and
a second switching unit configured to connect the second secondary battery set to one of the power generation device and the power consumption device.

10. The vehicle of claim 1, further comprising:
a third switching unit configured to connect in either series or parallel the at least two secondary batteries included in the first secondary battery set; and
a fourth switching unit configured to connect in either series or parallel the at least two secondary batteries included in the second secondary battery set.

11. A battery control device comprising:
first and second battery sets each comprising at least two batteries;
a charge amount comparator configured to compare a battery charge amount between the first and second battery sets; and
a charge and discharge controller configured to discharge a battery set of which the battery charge amount is larger between the first and second battery sets and to charge a remaining battery set, to connect in parallel the at least two batteries included in the battery set being charged and to connect in series the at least two batteries included in the battery set being discharged.

12. The battery control device of claim 11, further comprising:
a first switching unit configured to connect the first battery set to one of a power generation device and a power consumption device; and
a second switching unit configured to connect the second battery set to one of the power generation device and the power consumption device.

13. The battery control device of claim 11, further comprising:
a third switching unit configured to connect in either series or parallel the at least two batteries included in the first battery set; and
a fourth switching unit configured to connect in either series or parallel the two batteries included in the second battery set.

14. The battery control device of claim 12, wherein the power generation device is configured to generate power with energy supplied from an energy source comprising at least one of an engine, solar power and wind power.

15. The battery control device of claim 12, wherein the power generation device comprises at least one of:
a generator configured to convert rotational energy to electrical energy; and
an energy conversion device configured to convert energy to electrical energy.
